(19) United States
(12) Patent Application Publication
(10) Pub. No.: US 2010/0182791 A1
(43) Pub. Date: Jul. 22, 2010

(54) PACKAGE FOR LIGHT EMITTING ELEMENT AND LIGHT EMITTING DEVICE

(75) Inventors: Takuma Hitomi, Osaka (JP); Masanori Hongo, Osaka (JP); Hideki Ito, Osaka (JP); Kiyoshi Yamakoshi, Osaka (JP); Masami Fukuyama, Osaka (JP); Hideki Takagi, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: SANYO ELECTRIC CO., LTD., Osaka (JP); SANYO TUNER INDUSTRIES CO., LTD., Osaka (JP)

(21) Appl. No.: 12/688,227

(22) Filed: Jan. 15, 2010

(30) Foreign Application Priority Data
Jan. 22, 2009 (JP) 2009-011581
Mar. 31, 2009 (JP) 2009-085761

(51) Int. Cl. F21V 7/00; F21V 19/00

(52) U.S. Cl. 362/297; 362/382

(57) ABSTRACT

In a package for a light emitting element according to the present invention, a light reflecting plate is buried in a base substrate at a position below a cavity with a light reflecting surface thereof facing upward, a part of the ceramic forming the base substrate is interposed between the light reflecting surface of the light reflecting plate and a top surface of the base substrate, and at least the part is light-transmitting. A light emitting device comprises the package, and the light emitting element accommodated in the cavity of the package. In another light emitting device, a first reflector which is made of a metal material and reflects a light emitted from the light emitting element is buried in a frame body.

The applications Number 2009-011581 and 2009-085761, upon which this patent application is based, are hereby incorporated by reference.

### BACKGROUND OF THE INVENTION

1. Field of the Invention

The present invention relates to a package for mounting a light emitting element thereon (a package for a light emitting element), and to a light emitting device comprising the light emitting element and the package for the light emitting element.

2. Description of Related Art

Conventionally, in a light emitting device shown in FIG. 17, used is a package 102 for mounting thereon a light emitting element 101. The package 102 comprises a base substrate 103 and a frame body 104 each made of ceramic and which are integrally bonded together. The frame body 104 has a cavity 104a defined therein for accommodating the light emitting element 101. A metal layer 105 made of silver (Ag), aluminum (Al) or the like is formed in an area of a top surface of the base substrate 103, which forms a bottom surface of the cavity 104a. The light emitting element 101 is disposed in the cavity 104a at a position on the metal layer 105.

With the light emitting device described above, a light is emitted from the light emitting element 101 in all directions. The light upwardly emitted advances upward without change, while the light downwardly emitted is reflected on a surface of the metal layer 105 to advance upward, with a change of its advancing direction at the reflection.

However, in the light emitting device shown in FIG. 17, since the metal layer 105 is exposed to the top surface of the base substrate 103, the surface of the metal layer 105 could deteriorate due to oxidation to possibly reduce an optical reflectivity of the metal layer 105. Also, in the light emitting device having the cavity 104a filled with a resin 106 including a fluorescent material, as shown in FIG. 18, in order to enhance emission intensity of the light emitting device, the surface of the metal layer 105 could deteriorate due to chemical reaction between the metal layer 105 and the resin 106 to possibly reduce the optical reflectivity of the metal layer 105. Therefore, in the conventional light emitting devices, a sufficiently high emission intensity cannot be obtained.

Also, conventionally, for the light emitting device shown in FIG. 19, employed is a package 1100 for mounting a light emitting element 1122. The package 1100 comprises a base substrate 1110 and a frame body 1120 each made of ceramic and which are integrally bonded together. The frame body 1120 has a cavity 1130 defined therein for accommodating the light emitting element 1122. A metal layer 1140 made of silver (Ag), aluminum (Al) or the like is formed in an area which forms an inner side surface of the cavity 1130. The light emitting element 1122 is installed on a top surface of the base substrate 1110 made of ceramic. The cavity 1130 is filled with a resin 1150 including a fluorescent material.

With the light emitting device described above, the light is emitted from the light emitting element 1122 in all directions. The light upwardly emitted advances upward without change, while the light laterally emitted is reflected on a surface of the metal layer 1140 to advance upward, with a change of its advancing direction at the reflection.

However, in the light emitting device shown in FIG. 19, since the metal layer 1140 is exposed to a surface of the frame body 1120, because of reaction between the metal layer 1140 and the resin 1150 including the fluorescent material, the surface of the metal layer 1140 could deteriorate due to oxidation to possibly reduce the optical reflectivity of the metal layer 1140.

Also, even in the case where the cavity 1130 is not filled with the resin 1150 including the fluorescent material, because of deterioration with age or a heat of the light emitting device, the surface of the metal layer 1140 deteriorates due to oxidation or the like to reduce the optical reflectivity of the metal layer 1140. Therefore, in the conventional light emitting devices, a sufficiently high emission intensity cannot be obtained and maintained.

### SUMMARY OF THE INVENTION

In view of above described problem, an object of the present invention is to provide a package for a light emitting element and a light emitting device which are capable of maintaining a sufficiently high emission intensity.

A first package for a light emitting element according to the present invention comprises a base substrate made of ceramic, and a frame body made of ceramic arranged on a top surface of the base substrate and provided therein with a cavity for accommodating the light emitting element. A light reflecting plate is buried in the base substrate at a position below the cavity with a light reflecting surface thereof facing upward. A part of the ceramic forming the base substrate is interposed between the light reflecting surface of the light reflecting plate and the top surface of the base substrate, and at least the part is light-transmitting.

In the package for the light emitting element described above, since the light reflecting surface of the light reflecting plate is covered by the part of the ceramic forming the base substrate, the light reflecting surface of the light reflecting plate hardly deteriorates due to oxidation or chemical reaction.

Also, in the package for the light emitting element described above, the light-transmitting ceramic is interposed between the light reflecting surface of the light reflecting plate and the top surface of the base substrate. Therefore, in the case where the light emitting element is accommodated in the cavity, the light downwardly emitted from the light emitting element goes through the ceramic and is reflected on the light reflecting surface of the light reflecting plate to advance upward. As a result, the sufficient emission intensity is obtained in the package with the cavity accommodating the light emitting element therein.

A second package for a light emitting element according to the present invention is the first package for the light emitting element described above, wherein the light reflecting plate is formed of metal, and the base substrate is formed of a low temperature co-fired ceramic which can be simultaneously fired with the metal forming the light reflecting plate.

With the second package for the light emitting element described above, since the low temperature co-fired ceramic is light-transmitting, in the case where the light emitting element is accommodated in the cavity, the light downwardly emitted from the light emitting element can reach the light reflecting surface of the light reflecting plate. Accordingly, said light is reflected on the light reflecting surface to advance upward.

A third package for a light emitting element according to the present invention is the first or second package for the light emitting element described above, wherein the base substrate and the light reflecting plate are formed by firing a stacked body comprising a plurality of ceramic sheets stacked and a metal layer, which is to be the light reflecting plate, interposed between a pair of adjacent ceramic sheets among the plurality of ceramic sheets.

A fourth package for a light emitting element according to the present invention is any one of the first to third packages for the light emitting element described above, wherein a second light reflecting surface comprising an exposed surface of the ceramic forming the base substrate is formed in at least a part of an area of the top surface of the base substrate, which is a bottom surface of the cavity.

With the fourth package for the light emitting element described above, in the case where the light emitting element is accommodated in the cavity, a part of the light downwardly emitted from the light emitting element is reflected on the second light reflecting surface. The light which goes through the second light reflecting surface is reflected on the light reflecting surface of the light reflecting plate. Therefore, the light downwardly emitted from the light emitting element is upwardly guided efficiently. As a result, a higher emission intensity is obtained in the package with the cavity accommodating the light emitting element therein.

A first light emitting device according to the present invention comprises one of the first to fourth packages for the light emitting element described above and the light emitting element mounted on the package for the light emitting element. The light emitting element is accommodated in the cavity defined in the frame body of the package for the light emitting element.

A second light emitting device according to the present invention comprises a base substrate made of a ceramic material, a frame body made of the ceramic material arranged on a top surface of the base substrate, and a light emitting element arranged in a cavity defined by an inner circumferential surface of the frame body and the top surface of the base substrate. A first reflector which is made of a metal material and reflects a light emitted from the light emitting element is buried in the frame body.

A third light emitting device according to the present invention is the second light emitting device described above, wherein the first reflector includes a first reflecting surface which is generally perpendicular to the top surface of the base substrate and reflects toward inside of the cavity the light emitted from the light emitting element.

A fourth light emitting device according to the present invention is the third light emitting device described above, wherein the first reflecting surface includes a plurality of first part reflecting surfaces aligned so as to intermittently surround the cavity.

A fifth light emitting device according to the present invention is the fourth light emitting device described above, wherein the first reflecting surface includes a plurality of second part reflecting surfaces aligned so as to intermittently surround the cavity at positions on an outer side than the first part reflecting surfaces. The first part reflecting surfaces and the second part reflecting surfaces surround the cavity while covering gaps of each other.

A sixth light emitting device according to the present invention is any one of the second to fifth light emitting devices described above, wherein a second reflector which is made of a metal material and reflects the light emitted from the light emitting element is buried in the base substrate.

A seventh light emitting device according to the present invention is the sixth light emitting device described above, wherein the second reflector includes a second reflecting surface which is generally parallel to the top surface of the base substrate and reflects toward inside of the cavity the light emitted from the light emitting element.

An eighth light emitting device according to the present invention is the sixth or seventh light emitting device described above, wherein the first reflector extends into the base substrate and is connected to the second reflector.

### BRIEF DESCRIPTION OF THE DRAWINGS

FIG. 1 is a cross-sectional view of a ceramic body to be used for manufacturing a light emitting device according to a first embodiment of the present invention;

FIG. 2 is a cross-sectional view of a package produced by firing the ceramic body;

FIG. 3 is a cross-sectional view of the package with the light emitting element installed therein;

FIG. 4 is a cross-sectional view of a produced light emitting device;

FIG. 5 is a top view of a package for a light emitting device element of a light emitting device according to a second embodiment of the present invention viewed from top;

FIG. 6 is a view showing a stacking process of the package for the light emitting device element of the light emitting device according to the second embodiment of the present invention, and is a view of the package cut along a line A-A′ in FIG. 5;

FIG. 7 is a cross-sectional view of the package for the light emitting device element of the light emitting device according to the second embodiment of the present invention after firing;

FIG. 8 is a process drawing for arranging the light emitting device element in the package for the light emitting device element of the light emitting device according to the second embodiment of the present invention;

FIG. 9 is a process drawing for filling a resin in the package for the light emitting device element of the light emitting device according to the second embodiment of the present invention, and is a cross-sectional view of the light emitting device completed;

FIG. 10 is a cross-sectional view showing another example of the light emitting device according to the second embodiment of the present invention;

FIG. 11 is a cross-sectional view showing another example of the light emitting device according to the second embodiment of the present invention;

FIG. 12 is a cross-sectional view showing another example of the light emitting device according to the second embodiment of the present invention;

FIG. 13 is a top view of a light emitting device according to a third embodiment of the present invention viewed from top;

FIG. 14 is a cross-sectional view of the light emitting device according to the third embodiment of the present invention cut along a line B-B′;

FIG. 15 is a cross-sectional view of the light emitting device according to the third embodiment of the present invention;

FIG. 16 is a cross-sectional view of a light emitting device according to a fourth embodiment of the present invention;

FIG. 17 is a cross-sectional view showing an example of a conventional light emitting device;

FIG. 18 is a cross-sectional view showing another example of the conventional light emitting device; and

FIG. 19 is a cross-sectional view showing a further example of the conventional light emitting device.

### DETAILED DESCRIPTION OF THE PREFERRED EMBODIMENT

Preferred embodiments of the present invention are described in detail below with reference to the drawings.

### First Embodiment

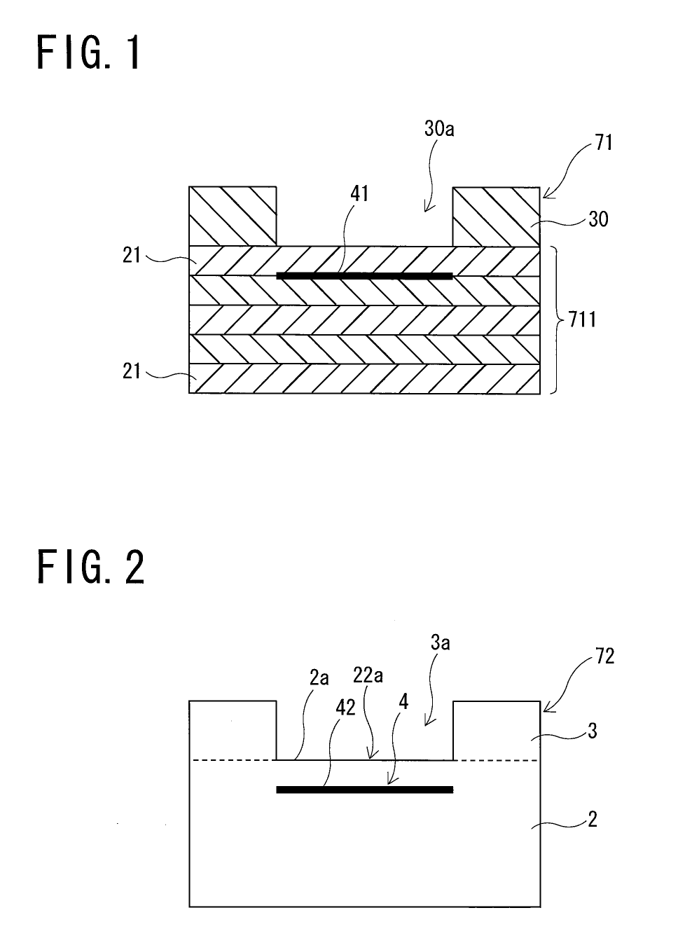

FIGS. 1 to 4 are cross-sectional views showing a manufacturing method of a light emitting device according to an embodiment of the present invention in the order of steps thereof.

First, in a ceramic body forming step, as shown in FIG. 1, by stacking a plurality of ceramic sheets 21 made of ceramic, a stacked body 711 of the ceramic sheets 21 is formed. At this time, a metal layer 41 is interposed between a pair of adjacent ceramic sheets 21 among the plurality of ceramic sheets 21. The metal layer 41 thereby extends along a plane perpendicular to a stacking direction of the ceramic sheets 21.

On the metal layer 41, superposed are one or more ceramic sheets 21 so that a distance between a top surface of the stacked body 711 and a top surface of the metal layer 41 is a predetermined length. Here, the predetermined length is a length with which the distance between the top surface of the stacked body 711 after firing (a top surface 2a of a base substrate 2 shown in FIG. 2) and the top surface of the metal layer 41 after firing (a light reflecting surface 42 of a light reflecting plate 4 shown in FIG. 2) is 0.1 mm to 0.4 mm.

For the metal layer 41, employed is a metal such as silver (Ag), aluminum (Al) or the like which can exhibit a high optical reflectivity. Also, as a ceramic forming the ceramic sheet 21, employed is a low temperature co-fired ceramic (LTCC) which can be simultaneously fired with the metal layer 41.

After forming the stacked body 711, a frame forming body 30 made of ceramic is superposed on the top surface of the stacked body 711. At this time, the frame forming body 30 is arranged so that a space 30a defined in the frame forming body 30 is located above the metal layer 41. A ceramic body 71 is thereby formed by the stacked body 711 and the frame forming body 30.

As ceramic forming the frame forming body 30, employed is the low temperature co-fired ceramic (LTCC) which can be simultaneously fired with the metal layer 41. The ceramic forming the frame forming body 30 may be the same as or different from one that forms the ceramic sheet 21.

Next, in a firing step, the ceramic body 71 formed in the ceramic body forming step is fired to form a package 72 for a light emitting element shown in FIG. 2. By firing the ceramic body 71, the stacked body 711 and the frame forming body 30 are sintered to form the base substrate 2 and a frame body 3 respectively, and the base substrate 2 and the frame body 3 are integrally bonded together as shown in FIG. 2.

Also, due to sintering of the frame forming body 30, the space 30a defined inside the frame forming body 30 becomes a cavity 3a for accommodating a light emitting element 1.

Further, due to sintering of the ceramic body 71, the metal layer 41 is also sintered to form the light reflecting plate 4 buried in the base substrate 2 at a position below the cavity 3a. Since the metal layer 41 extends along the plane perpendicular to the stacking direction as described above, a top surface of the light reflecting plate 4 obtained by firing the metal layer 41 can function as the light reflecting surface 42. Thus, the light reflecting plate 4 is positioned so that the light reflecting surface 42 thereof faces upward.

In this embodiment, the low temperature co-fired ceramic (LTCC) is used as the ceramic forming the ceramic body 71, and therefore, it is possible to sinter the ceramic at a temperature of 800 to 950 degrees C. Accordingly, it is possible to sinter the metal layer 41, while inhibiting abnormal contraction or the like of a metal used for the metal layer 41. Also, due to sintering, the low temperature co-fired ceramic crystallizes and becomes light-transmitting.

In the ceramic body 71, the one or more ceramic sheets 21 are superposed on the metal layer 41. Therefore, in the package 72 produced by firing the ceramic body 71, a part of the ceramic forming the base substrate 2 is interposed between the light reflecting surface 42 of the light reflecting plate 4 and the top surface 2a of the base substrate 2.

Accordingly, in the package 72, the light reflecting surface 42 of the light reflecting plate 4 is covered by the part of the ceramic forming the base substrate 2, and therefore, the light reflecting surface 42 of the light reflecting plate 4 hardly deteriorates due to oxidation or chemical reaction.

For the ceramic forming the base substrate 2 of the package 72, employed is the low temperature co-fired ceramic. The low temperature co-fired ceramic (LTCC) which crystallized as described above is light-transmitting, and therefore, a downward incident light from the cavity 3a to the base substrate 2 can reach the light reflecting surface 42 of the light reflecting plate 4, and is reflected on the light reflecting surface 42 to advance upward.

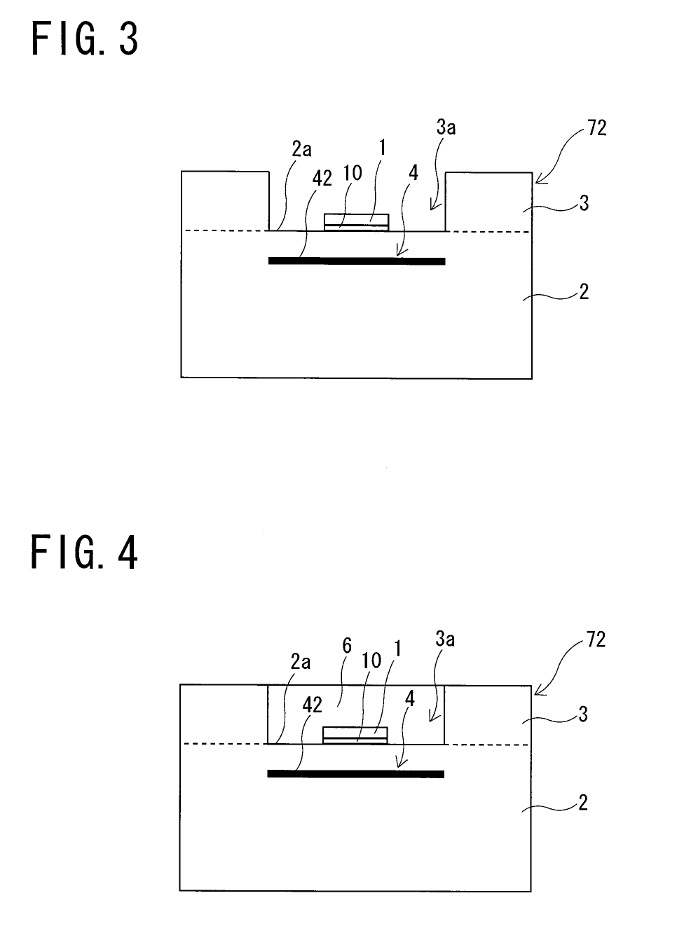

Next, in a light emitting element installation step, as shown in FIG. 3, the light emitting element 1 is installed in the package 72 produced in the firing step. In particular, the light emitting element 1 is installed in the cavity 3a at a position above the light reflecting plate 4 and on a die attach pad 10 disposed on the top surface 2a of the base substrate 2.

And then, in a resin filling step, as shown in FIG. 4, a resin 6 including a fluorescent material is filled in the cavity 3a, and the resin 6 is hardened. The light emitting device according to this embodiment of the present invention is thereby produced.

In the light emitting device described above, the light downwardly emitted from the light emitting element 1 is reflected on the light reflecting surface 42 of the light reflecting plate 4 buried in the package 72 to advance upward. As a result, the sufficient emission intensity is obtained in the light emitting device.

Accordingly, maintained is a sufficiently high emission intensity of the light emitting device.

In the package 72 described above, it is preferable that the distance between the top surface 2a of the base substrate 2 and the light reflecting surface 42 of the light reflecting plate 4 is 0.1 mm to 0.4 mm as described above. The reason is that in the case where said distance is smaller than 0.1 mm, a migration easily occurs in the light reflecting plate 4, while in the case where said distance is greater than 0.4 mm, an amount of light absorption by ceramic increases to reduce the reflectivity of the light downwardly emitted from the light emitting element 1.

However, the distance between the top surface 2a of the base substrate 2 and the light reflecting surface 42 of the light reflecting plate 4 can be smaller than 0.1 mm by employing a metal which hardly causes the migration as the metal forming the light reflecting plate 4.

Alternatively, the distance between the top surface 2a of the base substrate 2 and the light reflecting surface 42 of the light reflecting plate 4 can be smaller than 0.1 mm by employing a ceramic which can inhibit occurrence of the migration in the light reflecting plate 4 as the ceramic interposed between the light reflecting surface 42 of the light reflecting plate 4 and the top surface 2a of the base substrate 2.

As shown in FIG. 2, with the package 72 described above, on the top surface 2a of the base substrate 2, the part of the ceramic forming the base substrate 2 is exposed to the cavity 3a. Therefore, an exposed surface 22a of the ceramic can function as a second light reflecting surface which is different from the light reflecting surface 42 of the light reflecting plate 4. For example, employment of the ceramic sheet 21 with sufficiently small surface roughness in the ceramic body forming step reduces the surface roughness of the exposed surface 22a, resulting in the function of the exposed surface 22a as the second light reflecting surface.

In the case where the exposed surface 22a functions as the second light reflecting surface, a part of the light downwardly emitted from the light emitting element 1 accommodated in the cavity 3a is reflected on the second light reflecting surface, and the light which goes through the second light reflecting surface is reflected on the light reflecting surface 42 of the light reflecting plate 4. Therefore, the light downwardly emitted from the light emitting element 1 is upwardly guided efficiently, and a higher emission intensity of the light emitting device is maintained.

The present invention is not limited to the foregoing first embodiment in construction but can be modified variously within the technical range set forth in the appended claims.

For example, the metal forming the light reflecting plate 4 is not limited to silver (Ag) or aluminum (Al), but can be any of various metals which have high optical reflectivity.

### Second Embodiment

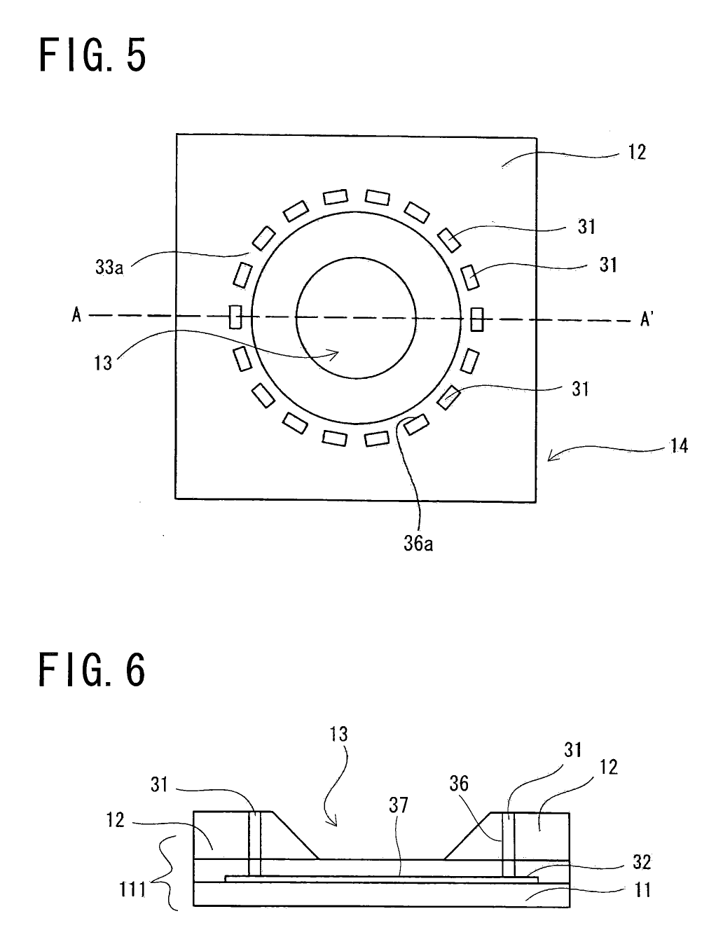

FIGS. 5 to 9 are cross-sectional views showing a manufacturing method of a light emitting device according to a second embodiment of the present invention in the order of steps thereof. FIG. 5 is a view of a package for a light emitting device element according to the second embodiment viewed from top. FIGS. 6 to 9 are cross-sectional views cut along a line A-A′ in FIG. 5.

First, in a ceramic body forming step, as shown in FIG. 6, by stacking a base substrate 11 (ceramic sheet) and a frame body 12 each made of a ceramic material, a stacked body 111 is formed. In the base substrate 11 and the frame body 12, buried are a first reflector 31 which is generally perpendicular to a top surface of the base substrate 11 and reflects a light from a light emitting element 22, and a second reflector 32 which is generally parallel to the top surface of the base substrate 11 and reflects the light from the light emitting element 22. The first reflector 31 forms a first reflecting surface 36, while the second reflector 32 forms a second reflecting surface 37. The reflectors are formed of a metal material having a good optical reflectivity such as silver or the like.

The first reflector 31 is formed by forming a via, which is a filling hole, in the base substrate 11 and the frame body (or, in only the frame body 12), and a silver paste or the like is filled in the via. The second reflector 32 is formed by applying the silver paste on a surface of the base substrate 11 by a doctor blade method or the like.

As shown in FIG. 5, a layer of the first reflectors 31 intermittently surrounds a cavity 13 and has gaps 33a. However, it is also possible that the layer of the first reflector 31 does not have the gaps 33a. Here, although it is preferred that the layer does not have the gaps 33a in view of reflection of the light from the light emitting element 22, the absence of the gaps 33a makes difficult the handling of the frame body 12 and the base substrate 11 since they will be separated by the first reflector 31.

As a ceramic forming the base substrate 11 and the frame body 12, employed is a low temperature co-fired ceramic (LTCC) which can be simultaneously fired with the silver paste. A ceramic material for high temperature firing can also be employed in combination with a metal having a high melting point.

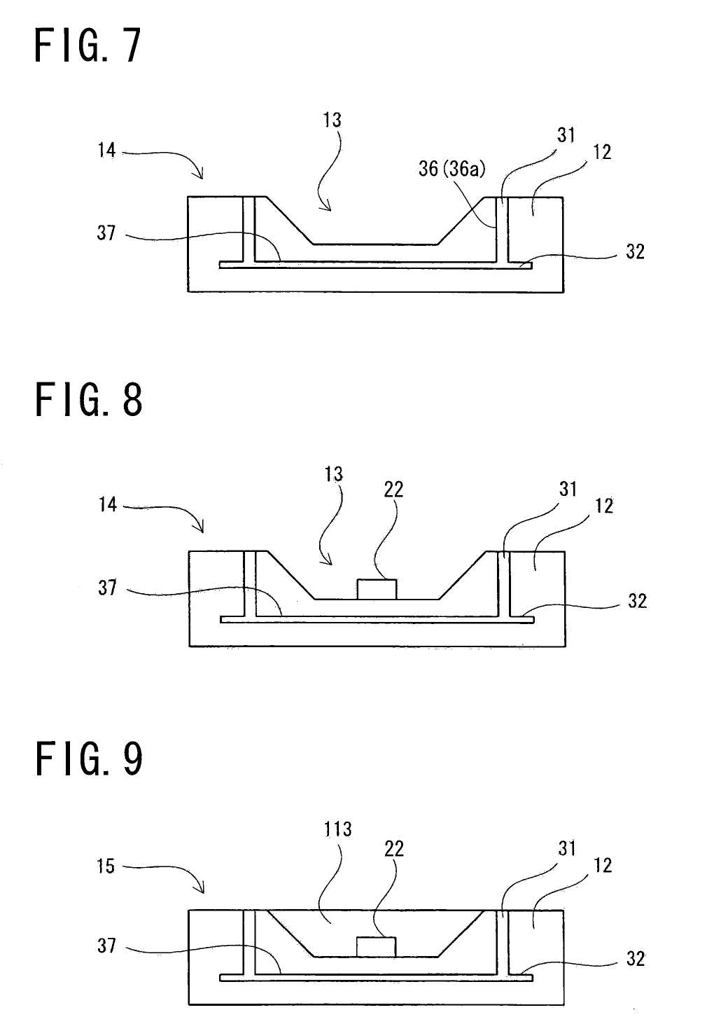

Next, in a firing step, the stacked body 111 formed in the ceramic body forming step is fired to form a package 14 for a light emitting element shown in FIG. 7. As shown in FIG. 7, the base substrate 11 and the frame body 12 are integrally bonded together.

At this time, the first reflecting surface 36 (which can also be a plurality of first part reflecting surfaces 36a aligned so as to surround the cavity 13) and the second reflecting surface 37 are respectively formed on the first reflector 31 which is formed by filling the silver paste or the like in the filling hole of the base substrate 11 and the frame body 12 and the second reflector 32 which is formed by applying the silver paste on the base substrate 11. And the first reflecting surface 36 and the second reflecting surface 37 are in contact with each other and bonded together. Thus, the first reflector 31 and the second reflector 32 do not have any gap therebetween, and they reflect the light from the light emitting element 22 without letting any of the light leak.

Also, due to sintering of the base substrate 11 and the frame body 12, a space defined by the top surface of the base substrate 11 and an inner circumferential surface of the frame body 12 becomes the cavity 13.

In this embodiment, the low temperature co-fired ceramic (LTCC) is used as the ceramic, and therefore, it is possible to sinter the ceramic at a temperature of 800 to 1000 degrees C., and to sinter a metal used for the first reflector 31 and the second reflector 32 while inhibiting abnormal contraction or the like of the metal.

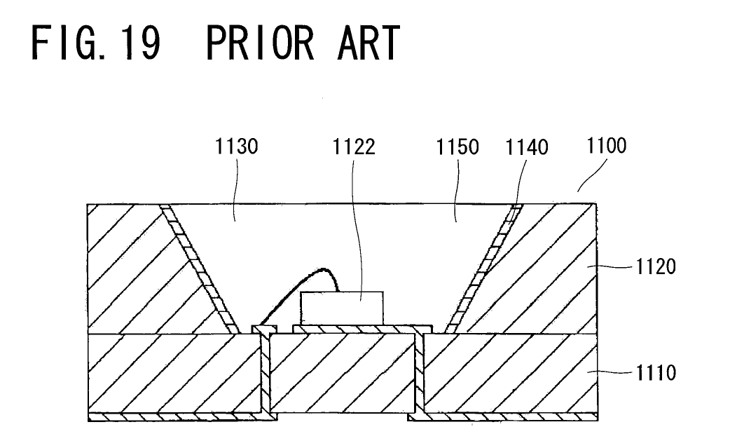

Next, in a step of installation of the light emitting element 22, as shown in FIG. 8, the light emitting element 22 is installed in the package 14 produced in the firing step. In particular, the light emitting element 22 is installed in the cavity 13 and on a pad or the like disposed in an area of the top surface of the base substrate 11, and then wiring for providing a power source or the like is installed. Here, since the light emitting element 22 is installed in the LTCC with the wiring by a conventional way, the wiring is not shown in the figure. The wiring is installed as shown in FIG. 19 for example.

And then, in a resin filling step, as shown in FIG. 9, a resin 113 including a fluorescent material is filled in the cavity 13, and the resin 113 is hardened. A light emitting device 15 according to the second embodiment of the present invention is thereby produced. Here, it is not always necessary to fill the resin 113 including the fluorescent material in the cavity 13.

As shown in FIG. 19 showing a conventional example, in a light emitting device with a reflector 1140 exposed to an inner circumferential surface of a cavity 1130, since the reflector 1140 is in direct contact with a resin 1150 including a fluorescent material, silver is oxidized and corroded, resulting in a decrease in the reflectivity.

Since the first reflector 31 and the second reflector 32 which reflect light, which are produced in the second embodiment, are buried in the base substrate 11 and the frame body 12, they do not come into direct contact with the resin 113 including the fluorescent material, and therefore, silver does not corrode and the reflectivity is maintained. Further, deterioration with age hardly occurs, and this increases reliability, resulting in the light emitting device 15 with the high emission intensity and which can maintain the high emission intensity.

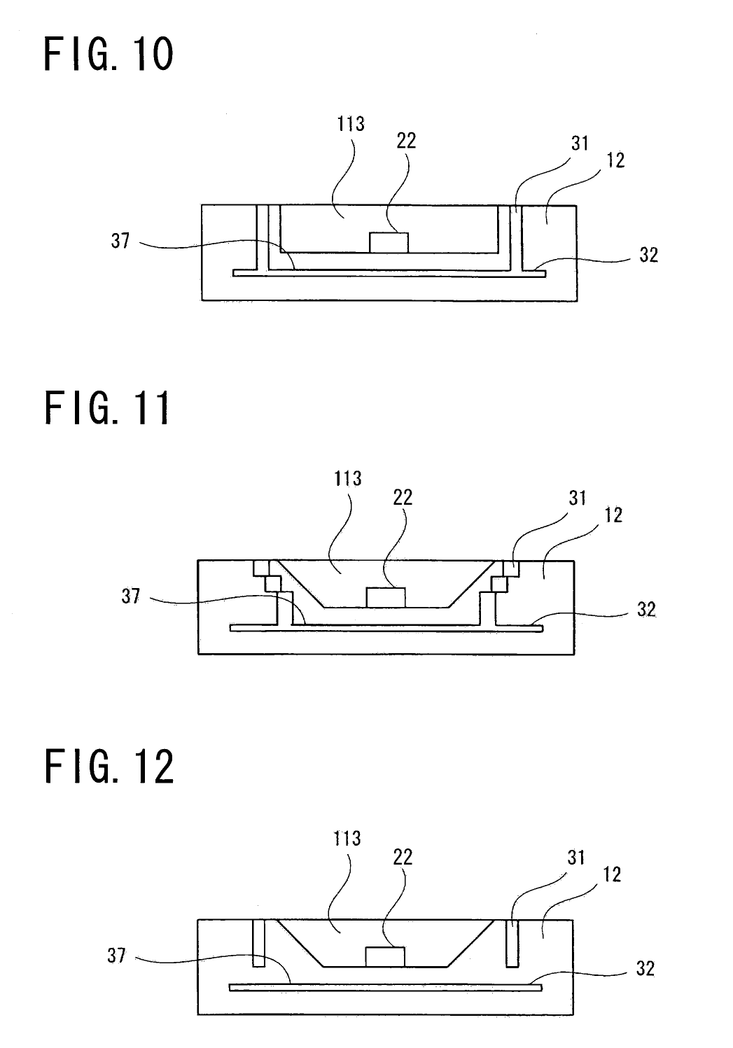

Further, a similar effect can be obtained even in the case where an inner circumferential surface of the cavity 13 is perpendicular to the top surface of the base substrate 2 as shown in FIG. 10.

Further, a similar effect can be obtained even in the case where the first reflector 31 is stepwise as shown in FIG. 11.

Further, a similar effect can be obtained even in the case where the first reflector 31 is formed only on the frame body 12 as shown in FIG. 12.

### Third Embodiment

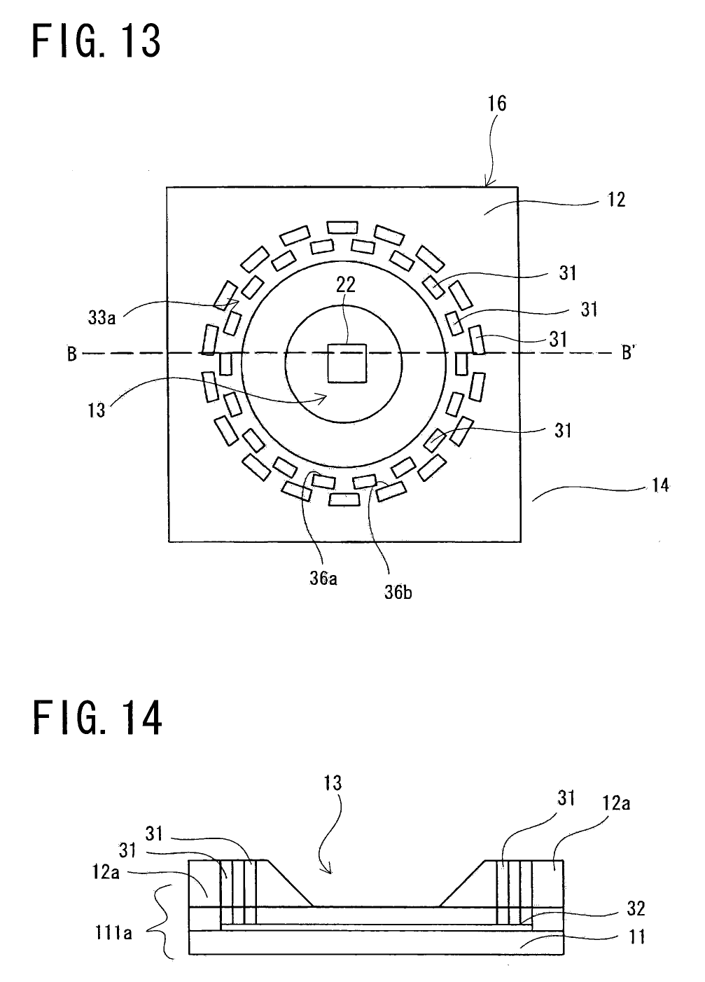

A third embodiment is described below with reference to FIGS. 13 to 15. Here, since the wiring for providing the power source or the like to the light emitting element 22 is installed in the LTCC by a conventional way, the wiring is not shown in the figure.

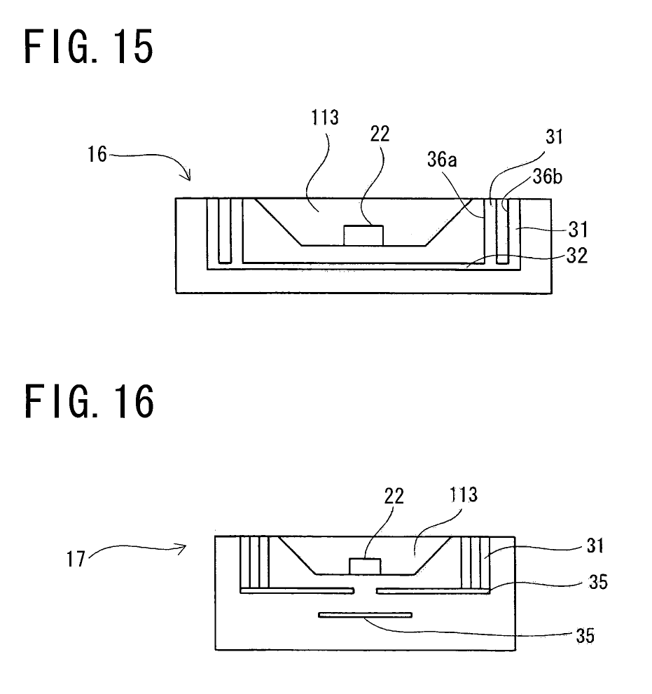

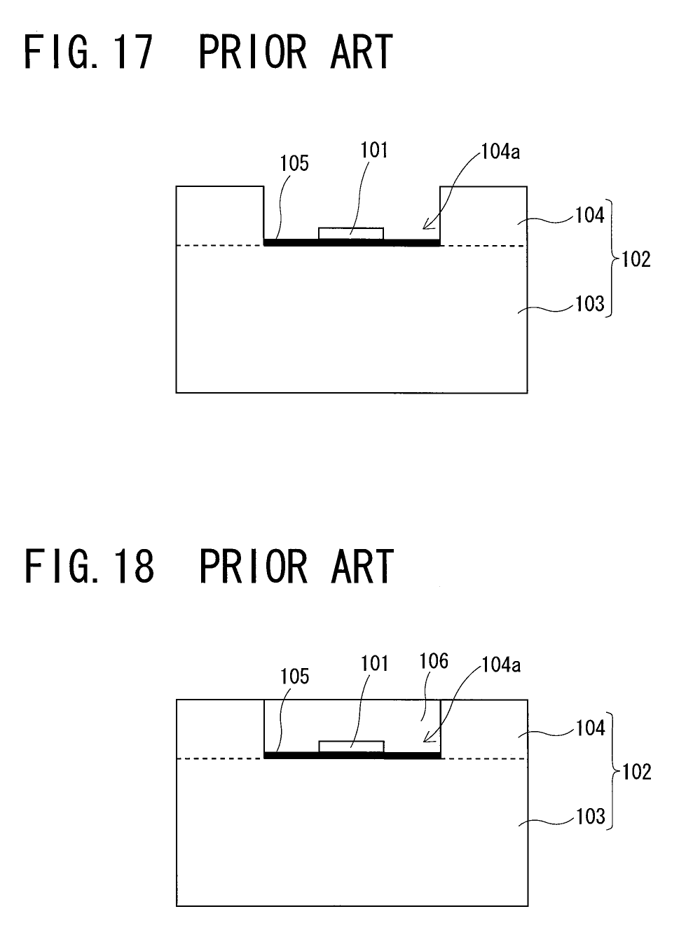

FIG. 13 is a view of a light emitting device 16 viewed from top. In this case, the light emitting element 22 is installed at a central part. FIGS. 14 and 15 are cross-sectional views cut along a line B-B′ in FIG. 13.

First, in a stacking step, as shown in FIG. 14, a plurality of first reflectors 31 are arranged in the base substrate 11 and a frame body 12a. FIG. 15 is a cross-sectional view of a completed product.

As shown in FIGS. 13, 14 and 15, the first reflectors 31 comprise the plurality of first part reflecting surfaces 36a aligned so as to intermittently surround the cavity 13, and a plurality of second part reflecting surfaces 36b aligned so as to intermittently surround the cavity at positions on an outer side than the first part reflecting surfaces 36a.

Further, the first part reflecting surfaces 36a and the second part reflecting surfaces 36b surround the cavity 13 while covering the gaps 33a of each other. As a result, leakage of the light from the light emitting element 22 is prevented.

Thereafter, in a similar manner to in the second embodiment, the firing, the arrangement of the light emitting element 22, and the filling of the resin 113 including the fluorescent material are performed to produce the light emitting device 16.

Although some of the light leaks from the gaps 33a of the first reflectors 31 in the second embodiment, the gaps 33a are covered so that the light leaking from the first part reflecting surfaces 36a is reflected by the second part reflecting surfaces 36b in the third embodiment with the configuration described above, resulting in the increase in the emission intensity further.

### Fourth Embodiment

A fourth embodiment is described below with reference to FIG. 16. A light emitting device 17 shown in FIG. 16 is the light emitting device 16 of the third embodiment, in which the second reflector 32 becomes intermittent to form a second reflector 35. The number of layers of the second reflector 35 is more than that of the second reflector 32 by one. Other components are the same as in the third embodiment.

Forming gaps in the second reflector 35 mitigates thermal expansion of the base substrate 11 and the second reflector 35 to reduce warpage after the firing, resulting in less warpage than in the second and third embodiments.

The present invention is not limited to the foregoing second to fourth embodiments in construction but can be modified variously within the technical range set forth in the appended claims.

What is claimed is:

1. A package for a light emitting element comprising a base substrate made of ceramic, and a frame body made of ceramic arranged on a top surface of the base substrate and provided therein with a cavity for accommodating the light emitting element,
wherein a light reflecting plate is buried in the base substrate at a position below the cavity with a light reflecting surface thereof facing upward, a part of the ceramic forming the base substrate is interposed between the light reflecting surface of the light reflecting plate and the top surface of the base substrate, and at least the part is light-transmitting.

2. The package for the light emitting element according to claim 1, wherein the light reflecting plate is formed of metal, and the base substrate is formed of a low temperature co-fired ceramic which can be simultaneously fired with the metal forming the light reflecting plate.

3. The package for the light emitting element according to claim 1, wherein the base substrate and the light reflecting plate are formed by firing a stacked body comprising a plurality of ceramic sheets stacked and a metal layer, which is to be the light reflecting plate, interposed between a pair of adjacent ceramic sheets among the plurality of ceramic sheets.

4. The package for the light emitting element according to claim 1, wherein a second light reflecting surface comprising an exposed surface of the ceramic forming the base substrate is formed in at least a part of an area of the top surface of the base substrate, which is a bottom surface of the cavity.

5. A light emitting device comprising the package for the light emitting element according to claim 1, and the light emitting element mounted on the package for the light emitting element, wherein the light emitting element is accommodated in the cavity defined in the frame body of the package for the light emitting element.

6. A light emitting device comprising a base substrate made of a ceramic material, a frame body made of the ceramic material arranged on a top surface of the base substrate, and a light emitting element arranged in a cavity defined by an inner circumferential surface of the frame body and the top surface of the base substrate, wherein a first reflector which is made of a metal material and reflects a light emitted from the light emitting element is buried in the frame body.

7. The light emitting device according to claim 6, wherein the first reflector includes a first reflecting surface which is generally perpendicular to the top surface of the base substrate and reflects toward inside of the cavity the light emitted from the light emitting element.

8. The light emitting device according to claim 7, wherein the first reflecting surface includes a plurality of first part reflecting surfaces aligned so as to intermittently surround the cavity.

9. The light emitting device according to claim 8, wherein the first reflecting surface includes a plurality of second part reflecting surfaces aligned so as to intermittently surround the cavity at positions on an outer side than the first part reflecting surfaces, and the first part reflecting surfaces and the second part reflecting surfaces surround the cavity while covering gaps of each other.

10. The light emitting device according to claim 6, wherein a second reflector which is made of a metal material and reflects the light emitted from the light emitting element is buried in the base substrate.

11. The light emitting device according to claim 10, wherein the second reflector includes a second reflecting surface which is generally parallel to the top surface of the base substrate and reflects toward inside of the cavity the light emitted from the light emitting element.

12. The light emitting device according to claim 10, wherein the first reflector extends into the base substrate and is connected to the second reflector.
